(19) United States
(12) Patent Application Publication
(10) Pub. No.: US 2008/0137353 A1
(43) Pub. Date: Jun. 12, 2008

(54) MULTI-MODE EXTERIOR LIGHTING ARCHITECTURES FOR AIRCRAFT

(76) Inventors: Ty A. Larsen, Everett, WA (US); Loc T. Tran, Bellevue, WA (US); Richard A. Cote, Mill Creek, WA (US)

Correspondence Address: INGRASSIA FISHER & LORENZ, P.C. (BOEING), 7010 E. Cochise Road, SCOTTSDALE, AZ, 85253, US

(21) Appl. No.: 11/608,779

(22) Filed: Dec. 8, 2006

(51) Int. Cl. B64D 47/02; B64F 1/20

(52) U.S. Cl. 362/470

(57) ABSTRACT

Multi-mode exterior lighting architectures for aircraft are provided. In accordance with an exemplary embodiment, an illumination system for illuminating a plurality of positions exterior to an aircraft includes a first light assembly coupled to the aircraft. The first light assembly is configured to produce a first light beam and direct the first light beam at a first position during a first operational mode and at a second position during a second operational mode. A second light assembly also is coupled to the aircraft and is configured to produce a second light beam and direct the second light beam at a third position during the first operational mode and at a fourth position during the second operational mode.

### TECHNICAL FIELD

The embodiments described herein generally relate to exterior lighting for aircraft, and more particularly relate to multi-mode exterior lighting architectures for airplanes.

### BACKGROUND

Airplanes make use of multiple types and locations of high intensity exterior lighting systems for various operational modes. The lighting architecture used on an airplane depends on the size of the airplane, the space available for light assembly placement, and the type of light sources to be used. Light sources typically used for exterior applications on airplanes include high intensity discharge (HID), incandescent, halogen incandescent, light emitting diode (LED), and sealed beam parabolic aluminized reflector (or “PAR”) lamps of various sizes.

Generally, at least one of three different types of lighting systems are used on airplanes. An example of a light architecture commonly used on airplanes is illustrated in FIGS. 1 and 2. Taxi light systems 102 are used on the ground to illuminate the pavement to the front of an airplane body 100. Taxi light systems typically include two high intensity light sources that are mounted on the nose gear 110 of the airplane, either in a fixed forward mount or on a movable portion of the nose gear so that, when the front nose wheels are turned in a particular direction, the light sources also are turned in that direction. Runway turnoff light systems 104 typically include two light sources that are each fixedly mounted on the leading edge of the wing root (also referred to as the strakelet) 112, that is, the portion of a wing 114 adjacent to the intersection of the wing and the fuselage 116, and point off from either side of the airplane to illuminate the runway and taxiways to the side during taxing. Runway turnoff lights are helpful during situations where the aircraft is being taxied during a turn, such as from the runway onto a taxiway. Certain larger airplanes, such as the Boeing® 747, may have runway turnoff light assemblies mounted on the nose gear. Landing light systems 106 illuminate the runway during takeoffs and landings. The systems typically include four high intensity light sources, with two light sources mounted on the leading edge of each wing root adjacent to the runway turnoff lights. Two light sources direct light forward toward the front of the airplane and two light assemblies direct light downward toward the front of the airplane. The lights are oriented to provide adequate runway illumination during approach and while the aircraft is flaring just before touchdown. An airplane may also have a wing illumination light assembly 108 mounted on each side of the fuselage to illuminate the wings for ice inspection. Taxi camera lighting systems, exterior cargo lighting systems, logo lighting systems, and the like may also be used.

Present day airplane lighting system architectures, however, suffer from several drawbacks. Typically, the above-described lighting systems each have a dedicated function. However, such single-function architecture is space and weight inefficient. Because the lighting systems perform only one function, they are used only for a short period of the airplane flight. For example, the landing lights typically are used only during take-offs and landings. During the remainder of the flight, the lighting systems are extra weight. An ongoing effort to decrease airplane weight, and thus increase fuel efficiency, makes a reduction in airplane lighting systems highly desirable.

In addition, it is difficult to design all the necessary lighting systems into smaller airplanes. Typically, light assemblies cannot be positioned on control surfaces, such as on the flaps of airplane wings. In addition, light assemblies cannot be positioned where they will interfere with the laminar flow of air over the airplane's surfaces. Retractable lighting systems mounted on the wings or within the fuselage have been used to overcome the design challenges. However, retractable lights, when deployed, face into the air stream. Vibration along with exposure to the elements and impact damage result in very low reliability of retractable lighting assemblies.

Further, designing the necessary lighting systems into small and large airplanes becomes difficult when new lighting technology is used. For example, one new technology considered for use on airplanes is high intensity discharge (HID) light sources, which are more efficient and have a longer life expectancy than commonly used incandescent or halogen incandescent sources that are used in PAR lamps. However, HID light sources require special ballasts that are larger and heavier than the transformers used for conventional lamps. In addition, larger HID sources typically start more slowly than incandescent/halogen sources, and many cannot be cycled on and off rapidly. To provide adequate start times, multiple smaller HID sources are often used in place of a single large HID source. HID light sources are also susceptible to mechanical vibration and shock damage, burn position misalignment, excessive numbers of start cycles, and the like.

Accordingly, it is desirable to provide an exterior illumination system for airplanes that decreases the number of light sources used and, hence, decreases the overall weight of the aircraft. In addition, it is desirable to provide a lighting system architecture for airplanes that does not expose light assemblies to damage from debris and vibration. It also is desirable to provide a lighting system architecture that can take advantage of new light technologies. Furthermore, other desirable features and characteristics of the below-described lighting architectures will become apparent from the subsequent detailed description and the appended claims, taken in conjunction with the accompanying drawings and the foregoing technical field and background.

### BRIEF SUMMARY

In accordance with an exemplary embodiment, an illumination system for illuminating a plurality of positions exterior to an aircraft comprises a first light assembly coupled to the aircraft. The first light assembly comprises a first light source. The first light assembly is configured to produce a first light beam from the first light source and direct the first light beam at a first position during a first operational mode and at a second position during a second operational mode. A second light assembly also is coupled to the aircraft and comprises a second light source. The second light assembly is configured to produce a second light beam from the second light source and direct the second light beam at a third position during the first operational mode and at a fourth position during the second operational mode.

In accordance with another exemplary embodiment, an airplane includes a body and a first light assembly coupled to the body. The first light assembly is configured to produce a first light beam and direct the first light beam at a first position when the airplane is directed along a first path, at a second position when the airplane is directed along a second path, and at the second position when the airplane is directed along a third path. A second light assembly is coupled to the body and is configured to produce a second light beam and direct the second light beam at a third position when the airplane is directed along the first path, at the third position when the airplane is directed along the second path, and at a fourth position when the airplane is directed along the third path.

In accordance with a further exemplary embodiment, an illumination system for illuminating a plurality of positions exterior to an aircraft is provided. The illumination system has a first light assembly that comprises a light source for producing a light beam, a first directing means for directing the light beam to a first position during a first operational mode of the aircraft, and a second directing means for directing the light beam to a second position during a second operational mode of the aircraft.

### BRIEF DESCRIPTION OF THE DRAWINGS

Various embodiments will hereinafter be described in conjunction with the following drawing figures, wherein like numerals denote like elements, and wherein:

FIG. 1 is a top view of an airplane with a conventional lighting architecture;

FIG. 2 is a side view of an airplane with a conventional lighting architecture;

FIG. 3 is a top view of an airplane with a lighting architecture that utilizes multi-functional light assemblies, in accordance with an exemplary embodiment;

FIG. 4 is a schematic view of a multi-functional light assembly of FIG. 3;

FIG. 5 is a side view of a light source movable by a chain or belt coupled to a motor in accordance with an exemplary embodiment;

FIG. 6 is a side view of a light source movable along a shaft via a jack screw arrangement in accordance with an exemplary embodiment;

FIGS. 7 and 8 are side views of a light source with a movable lens or reflector assembly in accordance with an exemplary embodiment;

FIGS. 9 and 10 are side views of a light source with a movable lens or reflector assembly in accordance with an exemplary embodiment;

FIG. 11 is a side view of a light source with a variable configuration reflector in accordance with an exemplary embodiment;

FIG. 12 is a side view of a light source with a variable configuration lens in accordance with an exemplary embodiment;

FIG. 13 is a side view of an airplane utilizing multi-function light assemblies that are coupled to the wing of the airplane and that are configured to function as landing light assemblies in accordance with an exemplary embodiment;

FIG. 14 is a side view of the airplane of FIG. 13 with the multi-function light assemblies configured to function as taxi lights in accordance with an exemplary embodiment;

FIG. 15 is a side view of an airplane utilizing multi-function light assemblies that are coupled to the nose gear of the airplane and that are configured to function as landing light assemblies in accordance with an exemplary embodiment;

FIG. 16 is a side view of the airplane of FIG. 15 with the multi-function light assemblies configured to function as taxi light assemblies;

FIG. 17 is a top view of an airplane utilizing multi-function light assemblies that are coupled to the nose gear of the airplane and that are configured to function as runway turnoff light assemblies in accordance with an exemplary embodiment;

FIG. 18 is a top view of the airplane of FIG. 17 with the multi-function light assemblies configured to function as landing light assemblies in accordance with an exemplary embodiment;

FIG. 19 is a top view of an airplane utilizing a set of multi-function light assemblies and a set of second light assemblies, with the multi-function light assemblies configured as runway turnoff light assemblies and with the second light assemblies configured as landing light assemblies in accordance with an exemplary embodiment;

FIG. 20 is a top view of the airplane of FIG. 19 with the multi-function light assemblies configured to augment the landing lights of the second light assemblies in accordance with an exemplary embodiment;

FIG. 21 is a top view of an airplane utilizing two sets of light assemblies, one set of which comprises multi-function light assemblies, with the multi-function light assemblies configured as runway turnoff light assemblies or as landing light assemblies in accordance with an exemplary embodiment;

FIG. 22 is a top view of the light patterns of the second set of light assemblies of FIG. 21 in accordance with an exemplary embodiment;

FIG. 23 is a side view of the light patterns of the second set of light assemblies of FIG. 22;

FIGS. 24-26 are top views of an airplane with steerable light assemblies in accordance with an exemplary embodiment; and

FIG. 27 is a top view of an airplane with multi-function light assemblies that are mounted in the fuselage of the airplane and that are configured to function as runway turnoff light assemblies and as wing illumination light assemblies in accordance with an exemplary embodiment.

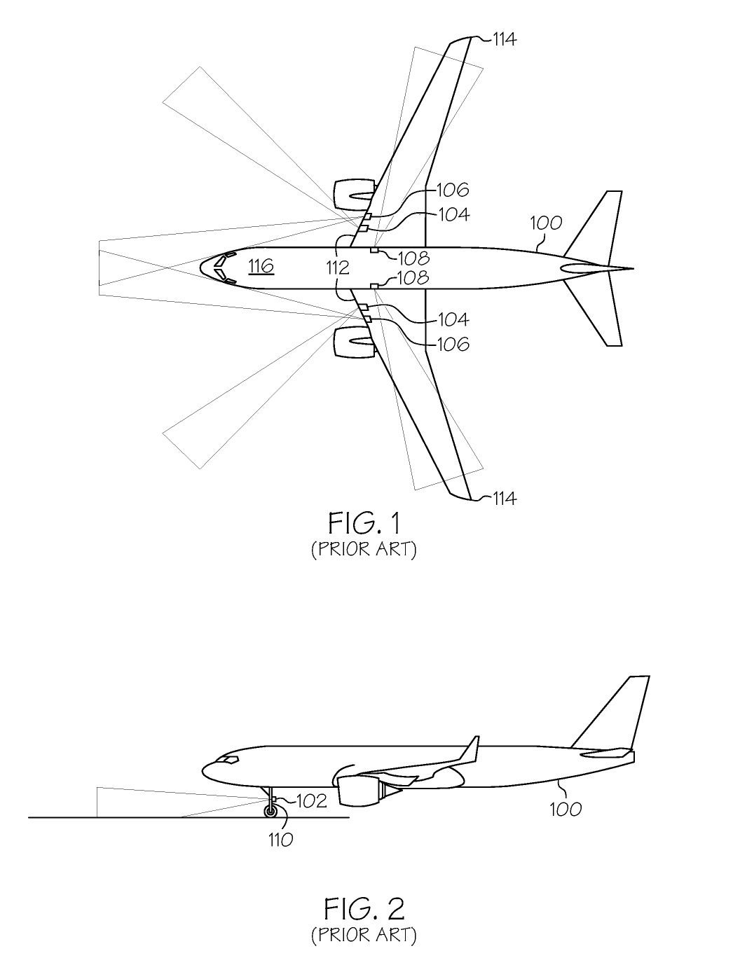

### DETAILED DESCRIPTION

The following detailed description is merely exemplary in nature and is not intended to limit the described embodiments or the application and uses of the described embodiments. Furthermore, there is no intention to be bound by any expressed or implied theory presented in the preceding technical field, background, brief summary or the following detailed description. In addition, while the figures used herein may indicate a particular model or manufacturer of an airplane, it is understood that the various embodiments are not limited to a particular model or manufacturer and can be used for any suitable aircraft.

The various embodiments of the novel airplane lighting system architecture described herein utilize multi-function light assemblies to perform various functions depending on the operational mode of the airplane. This architecture is a more efficient design strategy than conventional architectures utilizing single-function light assemblies. The various embodiments of the novel architecture can utilize light assemblies that are mounted into relatively protected areas of the airplane, where vibration, debris and wind are less likely to damage the assemblies. Because the light assemblies perform more than one function, fewer light assemblies are required on an airplane. Thus, space requirements and weight of the airplane are reduced.

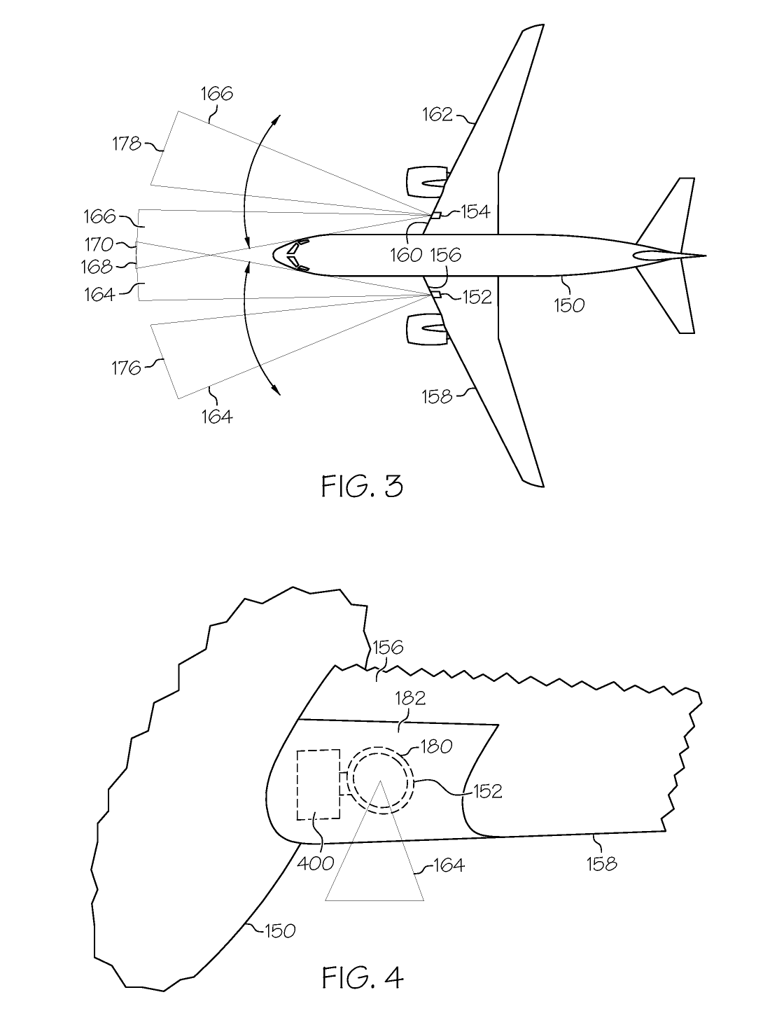

Referring to FIG. 3, in an exemplary embodiment, a first multi-function light assembly 152 is mounted on a wing root 156 of a first wing 158 of an airplane body 150 and a second multi-function light assembly 154 is mounted on a wing root 160 of a second wing 162. As described in more detail below, light assemblies 152 and 154 comprise at least one light source (not shown). Light beams 164 and 166 from light assemblies 152 and 154, respectively, can be directed at a first position with a first beam intensity pattern or at a second position with the first beam intensity pattern or a second beam intensity pattern depending on a selected operational mode of the airplane and thus the light assemblies 152 and 154 can perform different functions during different operational modes. For example, as illustrated in FIG. 3, during landing or takeoff, light assemblies 152 and 154 can function as landing light assemblies. Conventional landing lights typically produce narrower more intense light beams than conventional runway turnoff lights. In this regard, light assemblies 152 and 154 each would produce a narrow intense light beam 164 and 166 that is directed at a first position 168 and 170 toward the front of the plane, respectively. During taxing, light assemblies 152 and 154 can function as taxi lights or runway turnoff light assemblies. In this regard, light beams 164 and 166 of light assemblies 152 and 154 can be directed at a second position 176, 178 toward the front sides of the plane with a wider less intense intensity pattern.

The light assemblies 152 and 154, or light sources (not shown) of light assemblies 152 and 154, can move along a horizontal plane between the first or second position or, alternatively, can move horizontally and vertically. Switching of the positions of the light beams of the light assemblies may be performed by any suitable control mechanism accessible to pilots operating the airplane. In one exemplary embodiment, the pilots may be able to direct the light beams from the light assemblies using one or more joy stick-type devices or knobs. In another exemplary embodiment, the pilots may be able to direct the light beams from the light assemblies by flipping one or more levers or turning one or more switches that change the light beams from a landing light position to a taxiing or runway turnoff light position. In a further exemplary embodiment, a combination of one or more of these devices could be used. A default mode may also be selected for cases where two configurations are selected simultaneously. Other control means, such as on-screen computer control, touch screens, head-positioning monitoring, and the like also may be used to change the position of the light beams.

As described above, and as illustrated in FIG. 4, light assemblies 152 and 154 are mounted in the wing-roots 156 and 160 of wings 158 and 162, respectively. The light assemblies 152 and 154 can be mounted where landing lights conventionally are mounted at the wing-roots, where runway turnoff lights conventionally are mounted at the wing-roots, or at any other suitable position on the wing-root. Light assemblies 152 and 154 comprise at least one light source 180, such as a PAR lamp, an HID light source, or the like, mounted in the wing roots. In an exemplary embodiment, light assemblies 152 and 154 are mounted behind a window, lens or other transparent surface 182 disposed in the wing-root that protects the light source(s) from wind and debris. The light intensity pattern generated by the light source(s) 180 can be managed using changeable optics so that a desired wider, less intense pattern is produced while the light assemblies are serving as runway turnoff lights and a narrow, more intense pattern is produced while the light assemblies are serving as landing lights. The changeable optics may include adjustable lenses, adjustable reflectors, and the like.

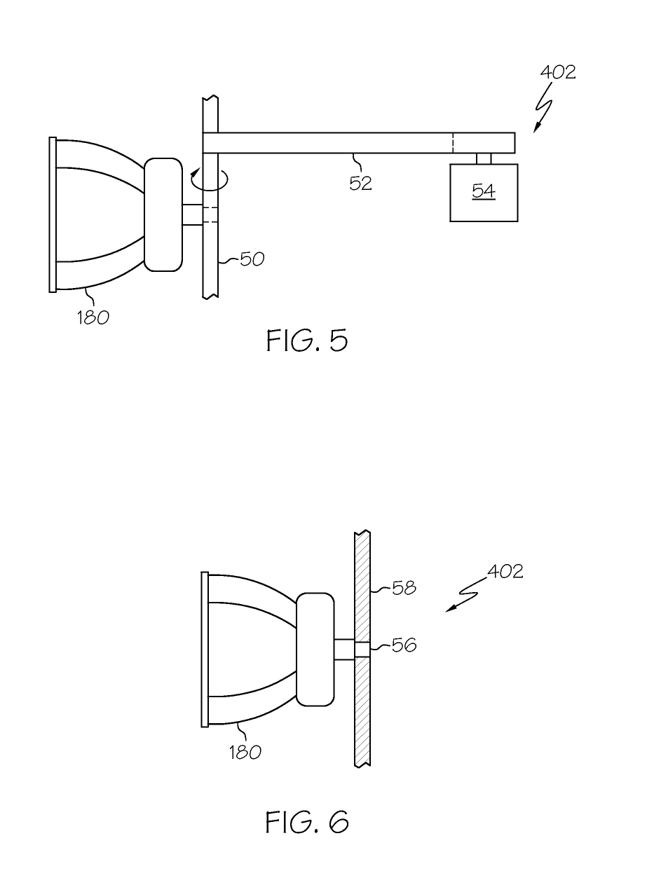

The light beams 164, 166 from light assemblies 152 and 154 can be directed to a first position, a second position, a third position, etc. by an electronic or mechanical directing means 400. In one embodiment, the light beams can be directed by moving or rotating light source(s) 180 from one orientation to another using electronic or mechanical moving means. For example, as illustrated in FIG. 5, light source 180 can be moved by a moving means 402 comprising a shaft 50 connected to an electric motor 54 via a chain or belt 52. In other embodiments, light source 180 can be transitioned back and forth along a shaft 56 via a jack screw arrangement 58 or a hydraulic arrangement, as illustrated in FIG. 6, can be moved by artificial muscle actuator devices, and the like. The light assemblies 152 and 154 also may comprise limit stops that prevent overshoot and hard stops that may damage the light sources. The light assemblies also may comprise a spring or other energy storage method that would return the light source to a default position upon loss of control of the switching components, or as means to reduce power demands or actuation times. In another embodiment, the light assemblies may monitor aircraft onboard sensors that determine if the airplane is on the ground or in the air and position the light source(s) 180 accordingly.

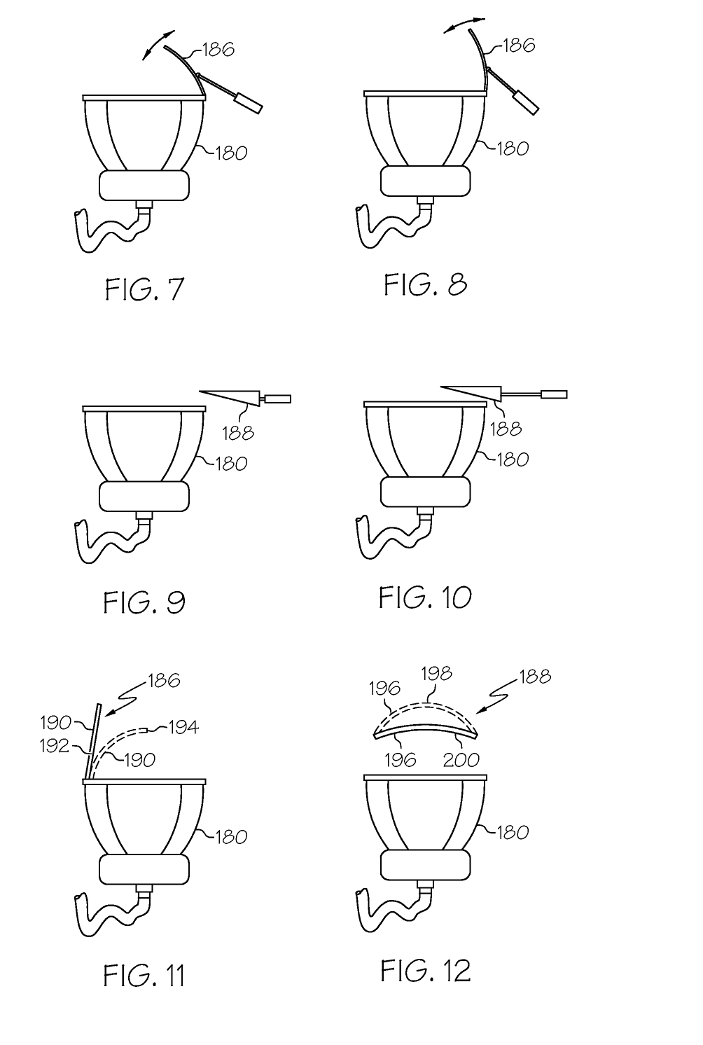

Referring to FIGS. 7 and 8, in another exemplary embodiment, the light sources 180 of light assemblies 152 and 154 are not movable and the directing means 400 is a reflector assembly 186 comprising one or more reflectors that is moved into or out of the light beam created by light source(s) 180 to direct the light beam(s) created by the light source(s) from a runway turnoff pattern to a landing/takeoff pattern, or from a landing/takeoff pattern to a runway turnoff pattern. A reflector assembly 186 can be moved into or out of the path of the light beam created by each light source 180 of the light assemblies or a reflector assembly 186 can be moved into or out of the path of light beams created by two or more light sources 180. The reflector assembly 186 can be moved or rotated from one orientation to another by electronic or mechanical means. For example, similar to the above-described means for moving light sources, reflector assembly 186 can be moved about a shaft connected via a chain or belt to an electric motor, can be transitioned back and forth along a shaft via a jack screw arrangement or a hydraulic arrangement, can be moved by artificial muscle actuator devices, and the like. The light assemblies 152 and 154 also may comprise limit stops that prevent overshoot and hard stops that may damage the reflector assemblies. The light assemblies also may comprise a spring or other energy storage method that would return the reflector assemblies to a default position upon loss of control of the switching components, or as means to reduce power demands or actuation times. In another embodiment, the light assemblies may monitor aircraft onboard sensors that determine if the airplane is on the ground or in the air and position the reflector assemblies accordingly. In another exemplary embodiment, the directing means 400 comprises a reflector assembly 186 and a moving means, such as moving means 402 of FIG. 5 or 6. In this regard, reflector assemblies 186 and the moving mechanisms that move the light sources 180 can be used to direct the light beams from a runway turnoff pattern to a landing/takeoff pattern, and vice versa. Alternatively, or in addition, reflector assemblies 186 can be used to refract the light of the light sources 180, thus increasing or decreasing the width of the light beam. Accordingly, reflector assemblies 186 can be used to widen or narrow the light beam as is suitable during taxing or landing/takeoff, respectively. In another exemplary embodiment, as illustrated in FIG. 11, reflector assemblies 186 can comprise variable configuration reflectors 190 that can be actuated to change from a first configuration or shape 192 to a second configuration or shape 194. For example, the variable reflector can be fabricated from a flexible material that can be manipulated by an actuator to change shape.

Referring to FIGS. 9 and 10, in another exemplary embodiment, the light source(s) of light assemblies 152 and 154 are not movable and the directing means 400 is a lens assembly 188 comprising one or more lenses that is moved into or out of the light beam created by light source(s) 180 to direct the light beams(s) created by the light sources(s) from a runway turnoff pattern to a landing/takeoff pattern or from a landing/takeoff pattern to a runway turnoff pattern. A lens assembly 188 can be moved into or out of the path of the light beam created by each light source 180 of the light assemblies or a lens assembly 188 can be moved into or out of the path of light beams created by two or more light sources 180. The lens assembly 188 can be moved or rotated from one orientation to another by electronic or mechanical means. For example, lens assembly 188 can be moved about a shaft connected via a chain or belt to an electric motor, can be transitioned back and forth along a shaft via a jack screw arrangement or a hydraulic arrangement, can be moved by artificial muscle actuator devices, and the like. The light assemblies 152 and 154 also may comprise limit stops that prevent overshoot and hard stops that may damage the lens assemblies. The light assemblies also may comprise a spring or other energy storage method that would return the lens assemblies to a default position upon loss of control of the switching components, or as means to reduce power demands or actuation times. In another embodiment, the light assemblies may monitor aircraft onboard sensors that determine if the airplane is on the ground or in the air and position the lens assemblies accordingly. In a further exemplary embodiment, the directing means 400 comprises a lens assembly 188 and a moving means, such as moving means 402 of FIG. 5 or 6. In this regard, lens assemblies 188 and the moving mechanisms that move the light source(s) 180 can be used to direct the light beams from a runway turnoff pattern to a landing/takeoff pattern, and vice versa. Alternatively, or in addition, lens assemblies 188 can be used to refract the light of the light source(s) 180, thus increasing or decreasing the width of the light beam as is suitable during taxing or landing/takeoff, respectively. In another exemplary embodiment, as illustrated in FIG. 12, lens assemblies 188 can comprise variable configuration lenses 196 that can be actuated to change from a first configuration or shape 198 to a second configuration or shape 200. For example, the variable configuration lens can be fabricated from a flexible material that can be manipulated by an actuator to change shape. In another embodiment, light assemblies 152 and 154 can use any combination of the lens assemblies 188, reflector assemblies 186, and moving means to direct the light beams from light source(s) 180. It will be appreciated that other devices and methods can be used to change the direction of the light beams from light sources 180 and the width of the light beams.

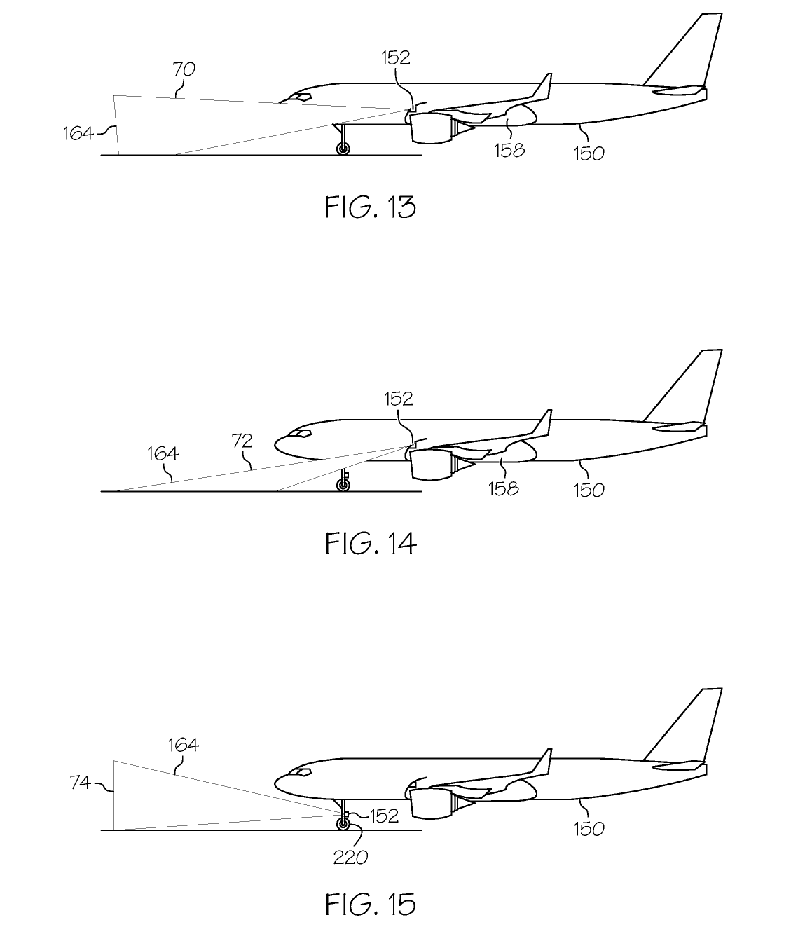

While the light assemblies 152 and 154 are described above for dual use as landing/takeoff lighting systems and as runway turnoff lighting systems, it will be appreciated that use of light assemblies 152 and 154 are not limited to these functions. For example, the light beams 164 and 166 produced by light assemblies 152 and 154 can be directed to a first position 70 so that light assemblies 152 and 154 can be used as landing light assemblies during landings/takeoffs, as illustrated in FIG. 13, and to a second position 72 so that light assemblies 152 and 154 can be used as taxi light assemblies during taxiing of the airplane, as illustrated in FIG. 14. Alternatively, light assemblies 152 and 154 can be used as landing lights during landing/takeoffs, as taxi lights during taxiing, and as runway turnoff lights during taxing.

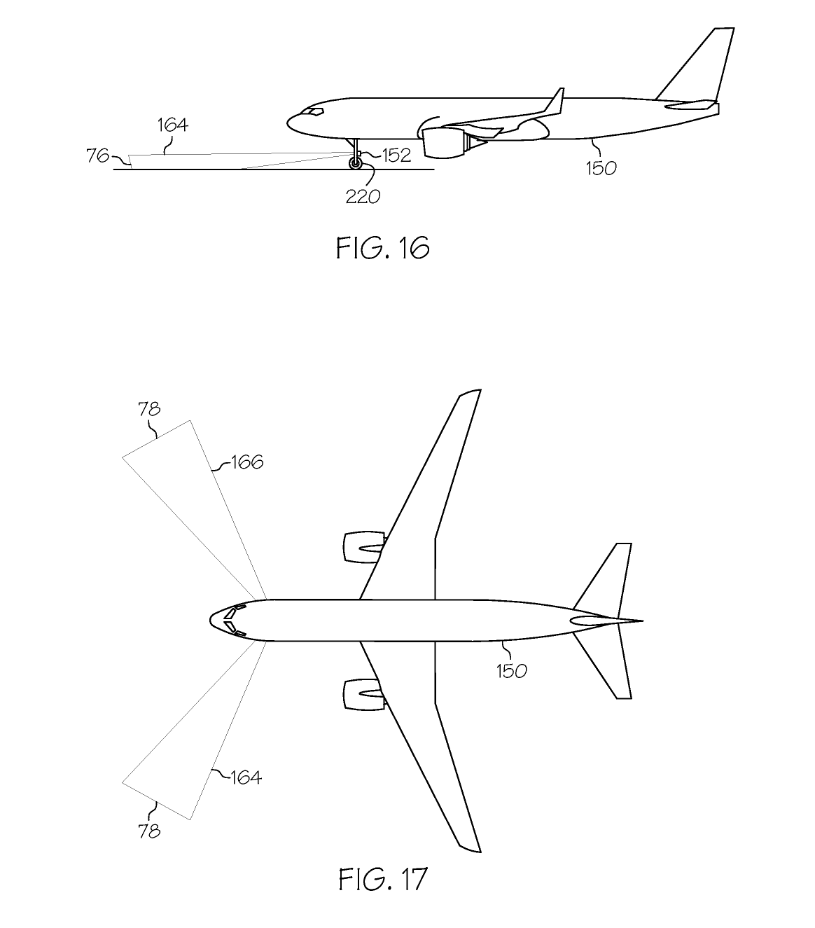

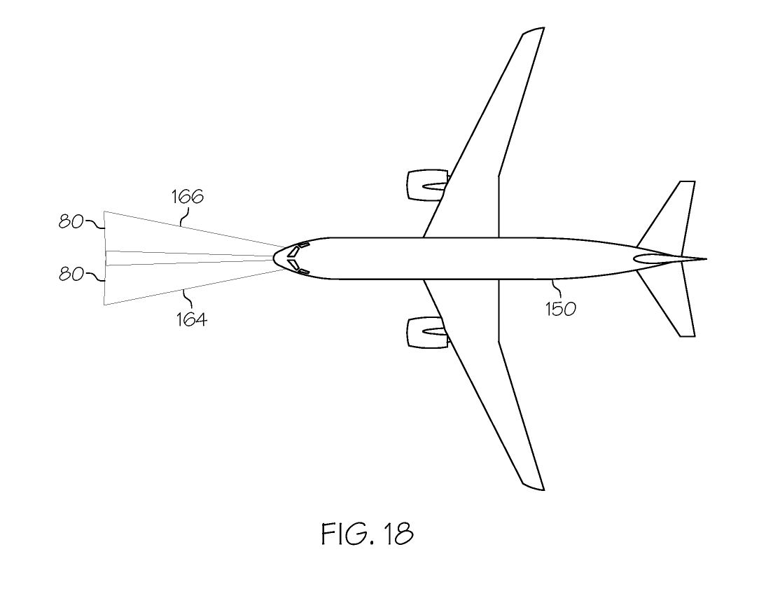

Referring to FIGS. 15 and 16, in another embodiment, at least one of the light assemblies 152 and 154 (hereinafter light assembly 152) is mounted on nose gear 220 of the airplane body 150. In this regard, the light beam 164 produced by light assembly 152 can be directed to a first position 74 so that the light assembly can function as landing light assembly during landings/takeoffs, as illustrated in FIG. 15, and to a second position 76 so that the light assembly can function as taxi light assembly during taxiing, as illustrated in FIG. 16. In another exemplary embodiment, the light beam 164 produced by light assembly 152 can be directed to a first position 78 so that light assembly 152 can function as a runway turnoff light assembly during taxiing, as illustrated in FIG. 17, and to a second position so that light assembly 152 can function as a landing light assembly during landings/takeoffs, as illustrated in FIG. 18. In a further embodiment, the light beam 164 produced by light assembly 152 can be directed so that light assembly 152 can function as a runway turnoff light and as a taxiing light. In yet another embodiment, the light beam 164 produced by light assembly 152 can be directed so that light assembly 152 can function as a runway turnoff light and/or as a taxiing light during taxiing and as a landing light during landing/takeoff. Alternatively, or in addition, at least one light assembly 152 can be coupled to or proximate to the nose region or tail region of the airplane body.

As described above, the light beams 164 and 166 of light assemblies 152 and 154 can be directed by using a moving mechanism that moves the light source(s) 180 of the light assemblies, by reflector assemblies and/or lens assemblies that are moved into the light beams to change their patterns, and/or by variable configuration reflectors and/or lenses. In addition, reflector and/or lens assemblies can be used to refract the light of the light source(s) of the light assemblies to widen or narrow the width of the light beams. In another embodiment, light assemblies 152 and 154 can use any combination of the above to direct the light beams from light source(s) 180.

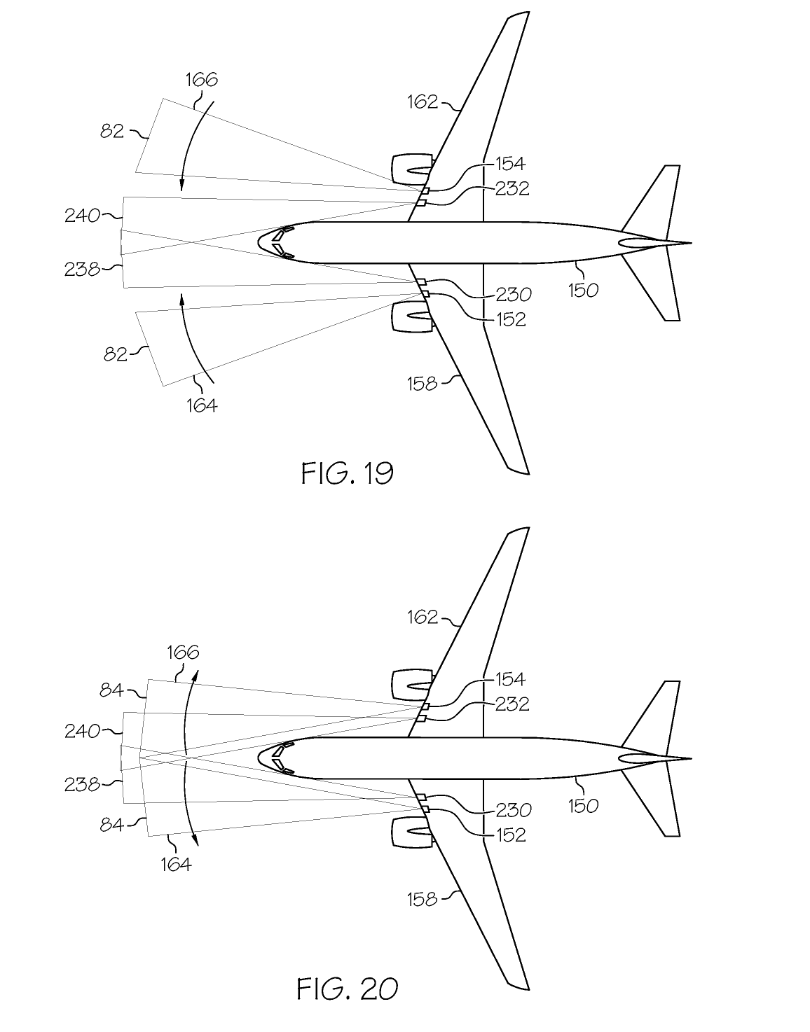

Light assemblies 152 and 154 can also be used to augment the light from another light assembly or light assemblies. For example, referring to FIGS. 19 and 20, each of light assemblies 152 and 154 can be mounted on the wing-root of the wings 158 and 162 of the airplane body 150 proximate to a second light assembly 230 and 232, respectively. Light beams 164 and 166 from light assemblies 152 and 154 can be directed to a first position so that light assemblies 152 and 154 function as runway turnoff lights while second light assemblies 230 and 232 produce light beams 238 and 240, respectively, to function as landing lights, as illustrated in FIG. 19. Referring to FIG. 20, the light beams 164 and 166 also can be directed to a second position 84 so that light assemblies 152 and 154 augment light beams 238 and 240 from second light assemblies 230 and 232, thus increasing the light used for landings/takeoffs. It will be appreciated that light assemblies 152 and 154 can be mounted and used for any other suitable function during one operational mode and to augment light beams of another light assembly during another operational mode. For example, at least one of the light assemblies 152 and 154 can be mounted on the nose or nose gear and can be used as a taxi light during taxiing and can be used to augment the light beams from landing lights during takeoffs/landings. Similarly, light assemblies 152 and 154 can be mounted on the wing roots and can be used as landing lights during takeoffs/landings and can be used to augment the light from runway turnoff lights or from taxi lights.

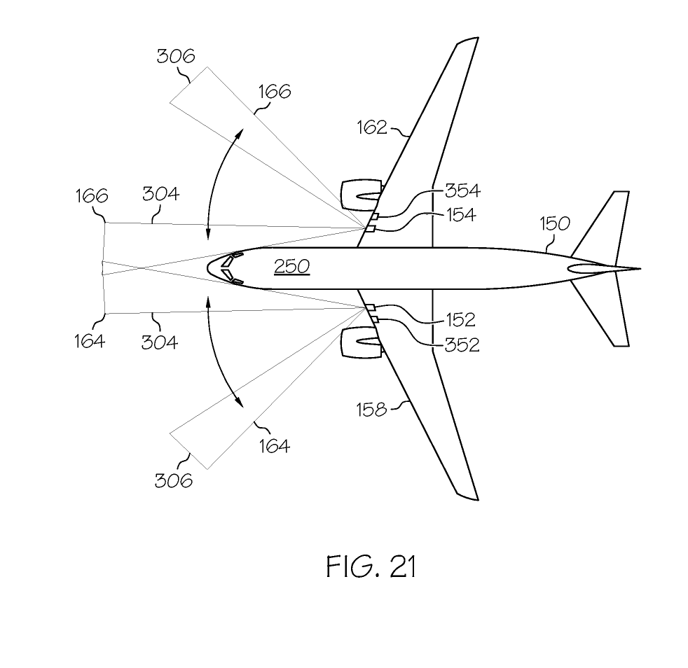

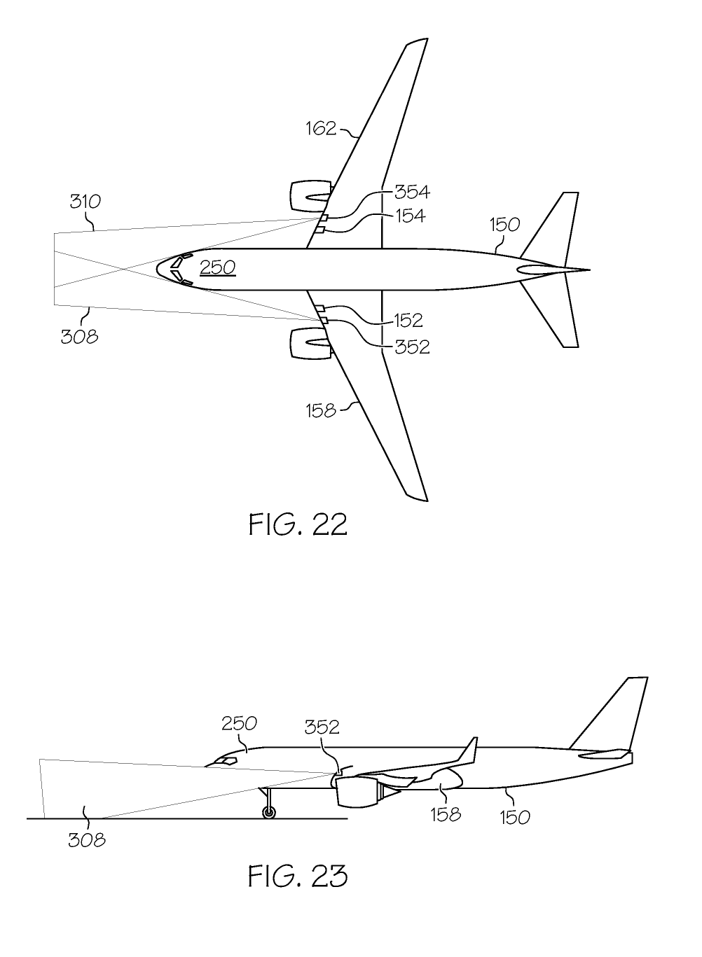

In another exemplary embodiment, lighting during the operational functions of landing/takeoff, runway turnoff, and taxiing can be performed by two sets of light assemblies. For example, as illustrated in FIG. 21, a first set of multi-function light assemblies 152 and 154 are mounted at the wing-roots of wings 158 and 162, respectively, close inboard to fuselage 250 of airplane body 150. During landing and takeoff, the light beams 164 and 166 produced by light assemblies 152 and 154, respectively, are directed to a first position 304 so that light assemblies 152 and 154 function as landing light assemblies. Light beams 164 and 166 also can be directed to a second position 306 so that light assemblies 152 and 154 function as runway turnoff light assemblies during taxiing. A second set of light assemblies 352 and 354 are mounted at the wing-roots of wings 158 and 162 outboard of light assemblies 152 and 154, respectively. Referring to FIGS. 22 and 23, in an exemplary embodiment, light assemblies 352 and 354 are configured so that their lighting patterns are canted slightly downward and turned slightly inboard. During landing, light beams 308 and 310 produced by light assemblies 352 and 354, respectively, illuminate the runway surface during landing. The canting of light beams 308 and 310 also would illuminate the area under the fuselage 250 that would typically be illuminated by conventional retractable and/or nose gear-mounted light assemblies. In another exemplary embodiment, light assemblies 352 and 354 also could be multi-function light assemblies that produce light beams that are directed from a first position, such as for landing, to a second position, such as taxiing.

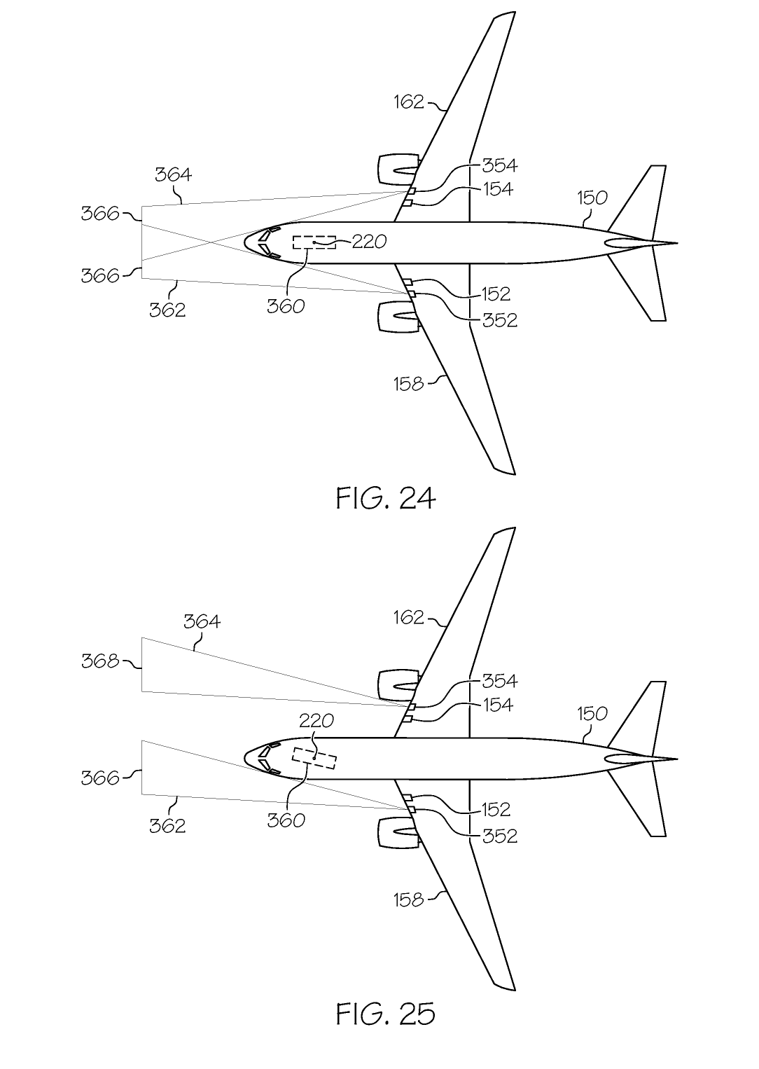

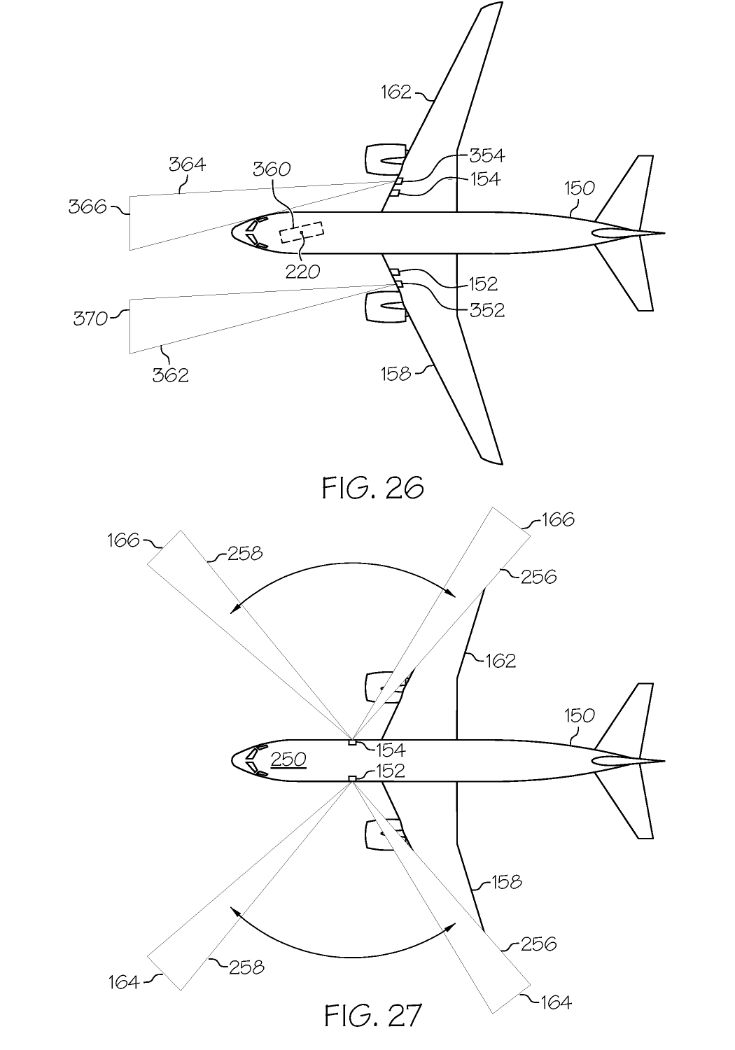

Referring to FIGS. 24-26, in another exemplary embodiment, light assemblies 352 and 354 are steerable, that is, the light beams produced from light assemblies 352 and 354 can be steered continuously from one position to another. In one embodiment, the light assemblies are coupled to a direction input mechanism 360, such as a lever, a joy stick, a steering wheel, or the line. In another embodiment, the direction input mechanism is the nose wheel 360 of nose gear 220. When the nose wheel is pointed substantially to the front of the airplane body 150, as illustrated in FIG. 24, light beams 362 and 364 produced by light assemblies 352 and 354 both point to the front of the aircraft at a first position 366. When the nose wheel 360 is rotated to the right, as illustrated in FIG. 25, light beam 364 from light assembly 354 is directed to a second position 368 corresponding to the direction that the nose wheel 360 is pointing. Light beam 362 produced from light assembly 352 remains at position 366 to illuminate the area to the front of the airplane. When the nose wheel 360 is rotated to the left, as illustrated in FIG. 26, light beam 362 from light assembly 352 is directed to a second position 370 corresponding to the direction that the nose wheel 360 is pointing. Light beam 364 produced from light assembly 354 would remain at position 366 to illuminate the area to the front of the airplane.

Referring to FIG. 27, in another exemplary embodiment, light assemblies 152 and 154 may be mounted within fuselage 250 of airplane body 150. Light beams 164 and 166 produced by light assemblies 152 and 154, respectively, can be directed to a first position 256 so that light assemblies 152 and 154 function as wing illumination light assemblies, such as during an ice inspection. Light beams 164 and 166 also can be directed to a second position 258 so that light assemblies 152 and 154 function as runway turnoff light assemblies during taxiing. As described above, the light beams of light assemblies 152 and 154 can be directed by using moving mechanisms that move or turn the light sources of the light assemblies, by reflector assemblies and/or lens assemblies that are moved into the light beams to change their patterns, and/or by variable configuration reflectors and/or lenses. In addition, reflector and/or lens assemblies can be used to refract the light of the light source(s) of the light assemblies to widen or narrow the width of the light beams. In addition, any combination of the above can be used to change the direction of light beams 164 and 166.

Accordingly, various embodiments of a novel airplane lighting system architecture have been described. The various embodiments utilize multi-function light assemblies to perform various functions depending on the operational mode of the airplane. While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the described embodiments in any way. Rather, the foregoing detailed description will provide those skilled in the art with a convenient road map for implementing the exemplary embodiment or exemplary embodiments. It should be understood that various changes can be made in the function and arrangement of elements without departing from the scope as set forth in the appended claims and the legal equivalents thereof.

1. An illumination system for illuminating a plurality of positions exterior to an aircraft, the illumination system comprising:
a first light assembly coupled to the aircraft and comprising a first light source, wherein the first light assembly is configured to produce a first light beam from the first light source and direct the first light beam to a first position during a first operational mode and to a second position during a second operational mode; and
a second light assembly coupled to the aircraft and comprising a second light source, wherein the second light assembly is configured to produce a second light beam from the second light source and direct the second light beam to a third position during the first operational mode and to a fourth position during the second operational mode.

2. The illumination system of claim 1, wherein the first light assembly is coupled to a wing root of a first wing of the aircraft and the second light assembly is coupled to a wing root of a second wing of the aircraft.

3. The illumination system of claim 2, wherein the first and second light sources are disposed behind a transparent surface.

4. The illumination system of claim 2, further comprising a third light assembly coupled to the wing root of the first wing proximate to the first light assembly and a fourth light assembly coupled to the wing root of the second wing proximate to the second light assembly and wherein, during the first operational mode, the first light beam directed to the first position augments a third light beam from the third light assembly and the second light beam directed to the third position augments a fourth light beam from the fourth light assembly, and during the second operational mode, the first light assembly and the second light assembly are directed to the second and fourth positions, respectively.

5. The illumination system of claim 2, further comprising a third light assembly coupled to the wing root of the first wing proximate to the first light assembly and a fourth light assembly coupled to the wing root of the second wing proximate to the second light assembly and wherein, during the first operational mode and the second operational mode, a light beam from the third light assembly is directed to a fifth position and a light beam from the fourth light assembly is directed to a sixth position.

6. The illumination system of claim 1, wherein the first light assembly comprises a first reflector assembly configured to direct the first light beam to the first position during the first operational mode and to the second position during the second operational mode and wherein the second light assembly comprises a second reflector assembly configured to direct the second light beam to the third position during the first operational mode and to the fourth position during the second operational mode.

7. The illumination system of claim 6, wherein the first reflector assembly comprises a first variable configuration reflector and the second reflector assembly comprises a second variable configuration reflector.

8. The illumination system of claim 1, wherein the first light assembly comprises a first lens assembly configured to direct the first light beam to the first position during the first operational mode and to the second position during the second operational mode and wherein the second light assembly comprises a second lens assembly configured to direct the second light beam to the third position during the first operational mode and to the fourth position during the second operational mode.

9. The illumination system of claim 8, wherein the first lens assembly comprises a first variable configuration lens and the second lens assembly comprises a second variable configuration lens.

10. The illumination system of claim 1, wherein the first light source and the second light source are movable.

11. The illumination system of claim 1, wherein the aircraft comprises nose gear and wherein the first light assembly and the second light assembly are coupled to the nose gear of the aircraft.

12. The illumination system of claim 1, wherein the first operational mode is taxiing of the aircraft and the second operational mode is landing or takeoff of the aircraft.

13. The illumination system of claim 1, wherein the first operational mode is runway turnoff and the second operational mode is landing or takeoff of the aircraft.

14. The illumination system of claim 1, wherein the first light assembly and the second light assembly are coupled to fuselage of the aircraft and wherein the first operational mode is runway turnoff and the second operational mode is wing illumination.

15. The illumination system of claim 1, wherein the first operational mode is runway turnoff and the first light beam is directed to the right of the aircraft if the aircraft is turning right and the second light beam is directed to the left of the aircraft if the aircraft is turning left.

16. An airplane comprising:
a body;
a first light assembly coupled to the body, wherein the first light assembly is configured to produce a first light beam and direct the first light beam to a first position when the airplane is directed along a first path, to a second position when the airplane is directed along a second path, and to the second position when the airplane is directed along a third path; and
a second light assembly coupled to the body, wherein the second light assembly is configured to produce a second light beam and direct the second light beam to a third position when the airplane is directed along the first path, to the third position when the airplane is directed along the second path, and to a fourth position when the airplane is directed along the third path.

17. The airplane of claim 16, wherein the body of the airplane comprises a nose wheel and wherein the positions of the first light beam and the second light beam correspond to positions of the nose wheel.

18. An illumination system for illuminating a plurality of positions exterior to an aircraft, the illumination system having a light assembly, the light assembly comprising:
a light source for producing a light beam;
a first directing means for directing the light beam to a first position during a first operational mode of the aircraft; and
a second directing means for directing the light beam to a second position during a second operational mode of the aircraft.

19. The illumination system of claim 18, wherein the first directing means and the second directing means are the same means.

20. The illumination system of claim 18, wherein the first directing means comprises a moving means.

21. The illumination system of claim 20, wherein the moving means comprises a shaft coupled to an electric motor via a chain or belt.

22. The illumination system of claim 20, wherein the moving means comprises a jack screw arrangement.

23. The illumination system of claim 18, wherein the first directing means comprises a lens assembly.

24. The illumination system of claim 18, wherein the first directing means comprises a reflector assembly.

25. The illumination system of claim 18, further comprising a third means configured to change the light beam from a first beam intensity pattern to a second beam intensity pattern.

26. The illumination system of claim 25, wherein the third means comprises a lens assembly.

27. The illumination system of claim 25, wherein the third means comprises a reflector assembly.

28. The illumination system of claim 18, wherein the light assembly is coupled to nose gear of the aircraft.

29. The illumination system of claim 18, wherein the light assembly is coupled to or proximate to a nose region of the aircraft.

30. The illumination system of claim 18, wherein the light assembly is coupled to a wing of the aircraft.
